(19) United States
(12) Patent Application Publication
(10) Pub. No.: US 2016/0144791 A1
(43) Pub. Date: May 26, 2016

(54) VEHICLE-MOUNTED DEVICE AND DISPLAY DEVICE

(71) Applicant: Yazaki Corporation, Tokyo (JP)

(72) Inventor: Tetsuya Sugiyama, Susono-shi (JP)

(21) Appl. No.: 15/012,193

(22) Filed: Feb. 1, 2016

Related U.S. Application Data
(63) Continuation of application No. PCT/JP2014/073512, filed on Sep. 5, 2014.

(30) Foreign Application Priority Data
Sep. 5, 2013 (JP) 2013-184226
Sep. 17, 2013 (JP) 2013-191466

(51) Int. Cl. B60R 1/076

(52) U.S. Cl. CPC B60R 1/076

(57) ABSTRACT

A display device includes: a concave mirror which is rotatable about a rotary shaft; and a stay formed of a base portion and a pair of raised wall portions mounted on the base portion in a raised manner and supporting the rotary shaft. The pair of raised wall portions is formed in an obliquely bent manner such that distal end portions of the raised wall portions extend away from each other thus allowing the raised wall portions easily deformable with a load applied in a raised direction.

### TECHNICAL FIELD

The present invention relates to a vehicle-mounted device and a display device, and more particularly to a vehicle-mounted device and a display device mounted on a vehicle.

### BACKGROUND ART

Conventionally, as the vehicle-mounted device described above, there has been proposed a display device shown in FIG. 10 (see Patent Literature 1, for example). As shown in the drawing, a display device 100 includes: a concave mirror 102 (rotary body) which is rotatable about a rotary shaft 101; a metal-made stay 103 (support body) which supports the concave mirror 102; and a housing (not shown in the drawing) which houses the concave mirror 102; the stay 103 and the like.

The concave mirror 102 reflects a display light emitted from a display unit not shown in the drawing. The stay 103 includes: a base portion 103A; and a pair of raised wall portions 103B which is mounted on the base portion 103A in a raised manner and supports the rotary shaft 101.

The above-mentioned display device 100 is mounted in the inside of an instrumental panel of a vehicle. Accordingly, when a vehicle causes a collision accident with a pedestrian, there is a possibility that the pedestrian collides with a portion of the vehicle in the vicinity of the display device 100. In this case, even when the housing is broken, the stay 103 made of metal exists in the inside of the housing. Accordingly, there exists a drawback that an impact generated at the time of collision cannot be efficiently absorbed.

### CITATION LIST

### Patent Literature

Patent Literature 1: JP 2011-131651 A

### SUMMARY OF INVENTION

### Technical Problem

Accordingly, it is an object of the present invention to provide a vehicle-mounted device and a display device which can efficiently absorb an impact.

### Solution to Problem

In order to solve the above-mentioned issue, an one aspect of the present invention is a vehicle-mounted device mounted on a vehicle, the vehicle-mounted device including: a rotary body which is rotatable about a rotary shaft; and a support body formed of a base portion and a pair of raised wall portions raised from the base portion and supporting the rotary shaft, wherein the pair of raised wall portions is formed into a shape which allows the raised wall portions to be deformable with a load applied in a raised direction.

A first preferred aspect of the present invention is the vehicle-mounted device according to the one aspect of the present invention, wherein distal end portions of the pair of raised wall portions are formed in an obliquely bent manner toward directions away from each other.

A second preferred aspect of the present invention is the vehicle-mounted device according to the one aspect or the first preferred aspect of the present invention, wherein end portions of the pair of raised wall portions on the base portion side are formed obliquely so as to be gradually away from each other in a direction toward the distal end portions of the pair of raised wall portions.

A third preferred aspect of the present invention is the vehicle-mounted device according to any one of the one aspect to the second preferred aspect of the present invention, wherein the raised wall portion is bent in a bellows shape.

Another aspect of the present invention is a vehicle-mounted device mounted on a vehicle, the vehicle-mounted device including: a rotary body; and a support body rotatably and pivotally supporting the rotary body, wherein an impact absorbing portion which moves the rotary body in an impact direction with respect to the support body in response to applying of an impact to the vehicle is provided to at least either one of the rotary body and the support body.

A first preferred aspect of the present invention is the vehicle-mounted device according to the another aspect of the present invention, wherein the rotary body includes a body portion and a shaft portion mounted on the body portion in a projecting manner, and the impact absorbing portion is a cut-out portion formed on the shaft portion.

A second preferred aspect of the present invention is the vehicle-mounted device according to the first preferred aspect of the present invention, wherein the support body includes a pair of raised plates which is disposed in a spaced-apart manner from each other and sandwiches the body portion in a projecting direction of the shaft portion, and the cut-out portion is formed on an intermediate portion between the body portion and the raised plate.

A third preferred aspect of the present invention is a display device including the vehicle-mounted device according to any one of the one aspect to the second preferred aspect of the present invention, wherein the rotary body is formed of a reflective member which reflects a display light.

### Advantageous Effects of Invention

As has been described heretofore, according to the one aspect to the seventh preferred aspect of the present invention, the pair of raised wall portions is formed into a shape which allows the raised wall portions to be deformable with a load applied in a raised direction. With such a configuration, when an impact load is applied to the raised wall portions in the raised direction, the raised wall portions are deformed so that the impact can be efficiently absorbed.

According to the first preferred aspect of the present invention, the distal end portions of the pair of raised wall portions are formed in an obliquely bent manner toward directions away from each other. With such a configuration, the pair of raised wall portions easily falls down in the directions away from each other in response to applying of an impact load from the raised direction and hence, the impact can be efficiently absorbed.

According to the second preferred aspect of the present invention, the end portions of the pair of raised wall portions on a base portion side are formed obliquely so as to be gradually away from each other in a direction toward the distal end portions of the pair of raised wall portions. With such a configuration, the pair of raised wall portions easily falls down in the directions away from each other in response to applying of an impact load from the raised direction and hence, the impact can be efficiently absorbed.

According to the third preferred aspect of the present invention, the raised wall portion is bent in a bellows shape. With such a configuration, the raised wall portion is deformed in a shrinking manner in response to applying of an impact load from the raised direction and hence, the impact can be efficiently absorbed.

According to the fourth and seventh preferred aspect of the present invention, the impact absorbing portion is provided to at least either one of the rotary body and the support body, and the impact absorbing portion moves the rotary body in an impact direction with respect to the support body in response to applying of an impact to the vehicle. That is, when an impact load is applied to the vehicle, the impact can be absorbed by moving the rotary body in the impact direction. Accordingly, for example, even when a collision accident with a pedestrian occurs, the rotary body moves and hence, the impact load can be efficiently absorbed thus alleviating the impact load applied to the pedestrian.

According to the fifth preferred aspect of the present invention, the rotary body includes the body portion and the shaft portion projecting from the body portion, and the impact absorbing portion is a cut-out portion formed on the shaft portion. That is, by forming the cut-out portion on the shaft portion, the shaft portion is broken at the cut-out portion in response to applying of an impact to the vehicle and hence, the rotary body moves in the impact direction from the support body. With such a configuration, it is possible to realize the structure where the impact absorbing portion moves the rotary body in the impact direction with respect to the support body in response to applying of an impact to the vehicle with simple working of forming the cut-out portion on the shaft portion while maintaining strength necessary for supporting the rotary body.

According to the sixth preferred aspect of the present invention, the support body includes a pair of raised plates which is disposed in a spaced-apart manner from each other and sandwiches the body portion in a projecting direction of the shaft portion, and the cut-out portion is formed on an intermediate portion between the body portion and the raised plate. With such a configuration, it is possible to realize the structure where the impact absorbing portion surely moves the rotary body in the impact direction with respect to the support body in response to applying of an impact to the vehicle with simple working of forming the cut-out portion on the shaft portion while maintaining strength necessary for supporting the rotary body.

### BRIEF DESCRIPTION OF DRAWINGS

FIG. 1 is a view for describing a mounting position of a display device which forms a vehicle-mounted device of the present invention.

FIG. 2 is a front view of a display device shown in FIG. 1 according to a first embodiment.

FIG. 3 is a front view of a display device shown in FIG. 1 according to a second embodiment.

FIG. 4 is a front view of a display device shown in FIG. 1 according to a third embodiment.

FIG. 5 is a view for describing a mounting position of a display device which forms a vehicle-mounted device of the present invention according to a fourth embodiment.

FIG. 6 is a plan view showing the display device shown in FIG. 5.

FIG. 7 is a perspective view showing the display device shown in FIG. 6.

FIG. 8 is a view for describing the manner of operation of the display device shown in FIG. 5.

FIG. 9 is a plan view showing a modification of a shaft hole used in the display device shown in FIG. 5.

FIG. 10 is a front view showing one example of a display device which forms a conventional vehicle-mounted device.

### DESCRIPTION OF EMBODIMENTS

### First Embodiment

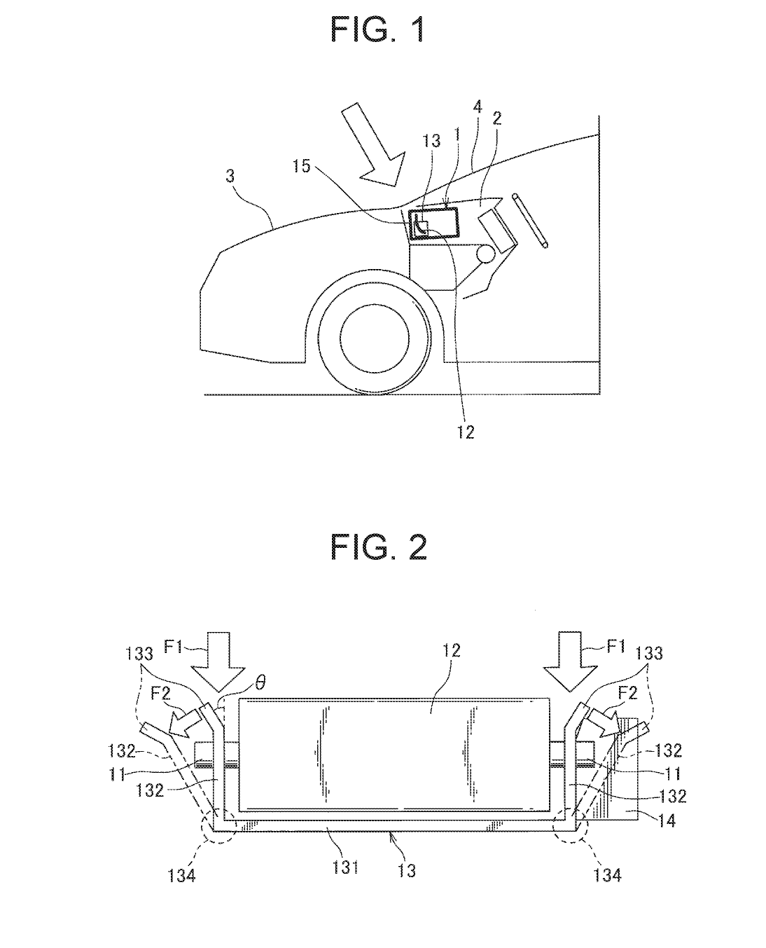

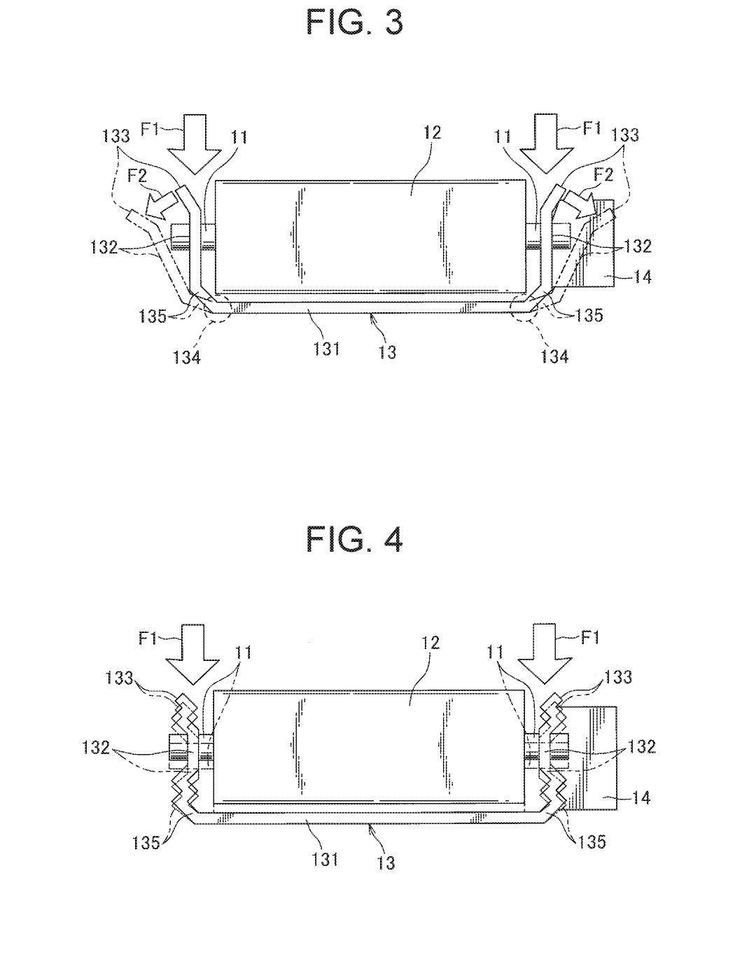

Hereinafter, a display device which forms a vehicle-mounted device of the present invention according to a first embodiment is described with reference to FIG. 1 and FIG. 2. The display device of the present invention forms a head-up display mounted on a vehicle where the head-up display reflects a display light emitted from a display unit such as a liquid crystal display not shown in the drawing and projects the display light to a windshield 4 thus allowing a user to visually recognize a virtual image.

As shown in FIG. 1, the display device 1 is housed in the inside of an instrumental panel 2 of the vehicle on a hood 3 side. As shown in FIG. 2, the display device 1 includes: a concave mirror 12 (a rotary body, a reflective member) which is rotatable about a rotary shaft 11; a metal-made stay 13 (a support body) which supports the concave mirror 12; a rotating mechanism part 14 which rotates the rotary shaft 11; and a housing 15 (see FIG. 1) which houses the concave mirror 12, the stay 13 and the rotating mechanism part 14.

The concave mirror 12 reflects a display light emitted from the display unit such as a liquid crystal display not shown in the drawing toward the windshield 4. Then, the display light is reflected on the windshield 4 and reaches a viewpoint of a driver, and the driver visually recognizes the display light as an enlarged virtual image. The rotary shaft 11 is mounted on both sides of the concave mirror 12 in a horizontally projecting manner respectively. Since making the concave mirror 12 rotatable about the rotary shafts 11, the driver can adjust a position of a virtual image to be visually recognized.

The stay 13 is formed by bending a sheet of elongated metal plate. As shown in FIG. 2, the stay 13 includes: a base portion 131; and a pair of raised wall portions 132 which is mounted on the base portion 131 in a raised manner and supports the rotary shafts 11. The base portion 131 is arranged horizontally.

Bent portions 134 which are bent at an approximately 90° are formed between the base portion 131 and the pair of raised wall portions 132. With such a configuration, the pair of raised wall portions 132 is mounted on the horizontal base portion 131 in a raised manner in the vertical direction. A hole portion (not shown in the drawing) which allows the rotary shaft 11 to pass therethrough is formed in the raised wall portion 132. By allowing the rotary shafts 11 to pass through the hole portions not shown in the drawing, the rotary shafts 11 are rotatably supported.

In a state where the rotary shafts 11 of the concave mirror 12 are supported by the stay 13, a lower end of the concave mirror 12 is spaced apart from the base portion 131. Further, the pair of raised wall portions 132 is formed into a shape which allows the raised wall portions to be deformable with a load applied from above in the vertical direction (raised direction). To be more specific, distal end portions 133 of the pair of raised wall portions 132 spaced apart from the base portion 131 are formed in an obliquely bent manner toward the directions away from each other. A bending angle θ is set to a value which falls within a range from 5° to 45° with respect to the vertical direction.

The rotating mechanism part 14 is formed of a motor and the like, and generates a driving force for rotating the rotary shafts 11. The housing 15 is formed of a member having low rigidity such as a resin, for example, and is configured to be easily broken when an impact load F1 is applied to the housing 15.

Next, a case where an impact load F1 is applied to the above-mentioned display device 1 from above is described. Firstly, prior to the description of the present invention is made, a case where an impact load F1 is applied to a conventional display device 100 shown in FIG. 10 from above is described. In the conventional display device 100, raised wall portions 103B are mounted on a base portion 103A in a state where the raised wall portion 103B stands upright in the vertical direction from an end portion on a base portion 103A side to a distal end portion thereof. Accordingly, even when an impact load F1 along the vertical direction (raised direction) is applied to the raised wall portion 103B, the raised wall portions 103B are minimally deformed thus impeding the absorption of an impact.

To the contrary, in the display device 1 according to the present invention shown in FIG. 1, the distal end portion 133 of the raised wall portion 132 is formed in an obliquely bent manner. With such a configuration, when an impact load F1 along the vertical direction is applied to the raised wall portions 132, a component force F2 which expands the distal end portion 133 of the raised wall portion 132 by pushing is generated. Accordingly, as indicated by a chain line in the drawing, the bent portions 134 are deformed such that the pair of raised wall portions 132 falls in the directions away from each other and hence, an impact can be efficiently absorbed.

### Second Embodiment

Next, a second embodiment of the present invention is described. A point which makes the second embodiment different from the first embodiment lies in a shape of a raised wall portion 132. In the first embodiment, the bent portions 134 formed between the base portion 131 and the pair of raised wall portions 132 are bent at 90°. However, in the second embodiment, bent portions 134 are bent at an angle larger than 90°. With such a configuration, end portions 135 of a pair of raised wall portions 132 on a base portion 131 side are formed obliquely such that the end portions 135 are gradually away from each other as the raised wall portions 132 extend toward distal end portions 133 respectively. Further, by bending portions of the end portions 135 on a distal end portion 133 side in the direction that the portions approach each other, a portion of the raised wall portion 132 between the end portion 135 and the distal end portion 133 is arranged to extend along the vertical direction.

Also in this case, in the same manner as the case of the first embodiment, when an impact load F1 along the vertical direction is applied to the raised wall portion 132, a component force F2 which expands the distal end portion 133 of the raised wall portion 132 by pushing is generated. Accordingly, as indicated by a chain line in the drawing, the bent portions 134 are deformed such that the pair of raised wall portions 132 falls in the directions away from each other. Further, the end portions 135 of the pair of raised wall portions 132 on a base portion 131 side are formed in an obliquely bent manner in the directions away from each other and hence, the pair of raised wall portions 132 more easily falls in the directions away from each other and hence, an impact can be absorbed more efficiently.

In the above-mentioned second embodiment, both the distal end portion 133 and the end portion 135 are formed obliquely. However, the present invention is not limited to such a configuration. It may be adopted a configuration where only the end portion 135 is formed obliquely, and the distal end portion 133 is provided so as to stand straight up along the vertical direction in the same manner as the conventional configuration. Also in this case, the pair of raised wall portions 132 easily falls down in the directions away from each other due to an impact load F1 and hence, the impact can be absorbed.

### Third Embodiment

Next, a third embodiment of the present invention is described. A point which makes the third embodiment different from the first embodiment lies in that, in each one of a pair of raised wall portions 132, a portion between a distal end portion 133 and an end portion 135 is formed in a bellows shape. With such a configuration, even when the pair of raised wall portions 132 does not fall in directions away from each other at the time of applying of an impact load F1, as indicated by a chain line, the raised wall portions 132 are easily deformed in a shrinking manner in a vertical direction and hence, an impact can be efficiently absorbed.

In the above-mentioned third embodiment, both the distal end portions 133 and the end portions 135 are formed obliquely such that the distal end portions 133 and the end portions 135 are respectively gradually away from each other as the raised wall portions 132 extend toward distal ends thereof respectively. However, the present invention is not limited to such a configuration. It is sufficient that the raised wall portion 132 is formed in a bellows shape. The distal end portions 133 and the end portions 135 may be formed so as to extend upright along the vertical direction, or may be formed obliquely so as to approach each other as the raised wall portions 132 extend toward distal ends thereof respectively.

In the above-mentioned first to third embodiments, the description is made with respect to the case where the concave mirror 12 is used as the rotary body, for example. However, the present invention is not limited to such a case. The display unit per se may be used as the rotary body, or another electronic equipment may be used as the rotary body.

In the above-mentioned embodiments, the base portion 131 of the stay 13 is arranged horizontally and the raised wall portions 132 are arranged vertically. However, the arrangement of these portions is not limited to such an arrangement.

### Fourth Embodiment

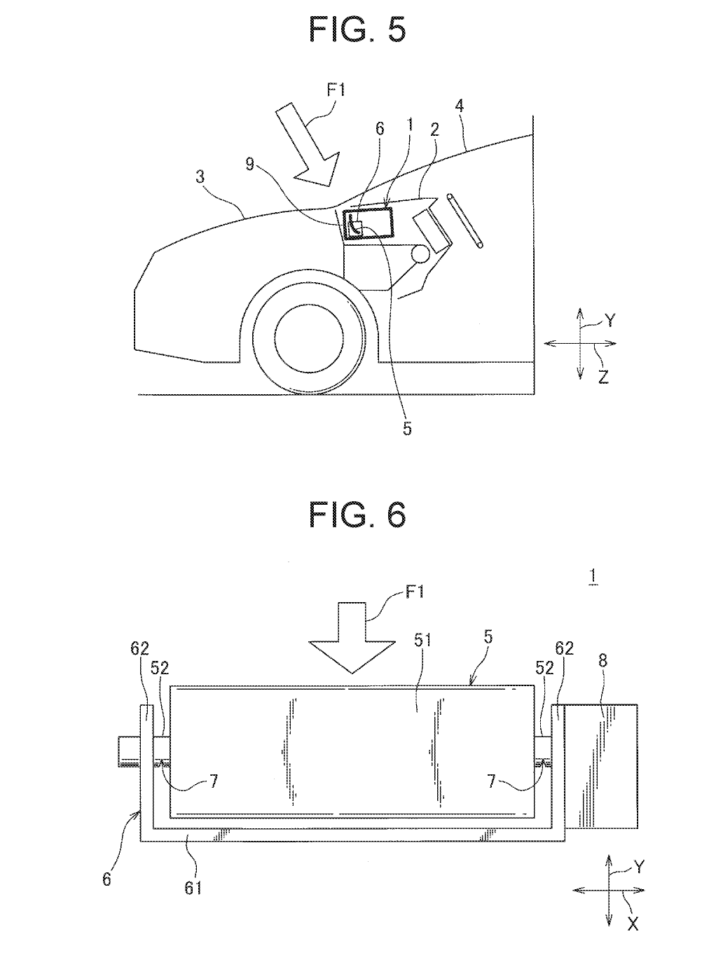

Next, fourth embodiment of the present invention is described with reference to FIG. 5 to FIG. 8. A display device 1 according to the fourth embodiment forms a head-up display device mounted on a vehicle, wherein a display light emitted from a display unit such as a liquid crystal display not shown in the drawing is reflected on a windshield 4 and is transmitted to a viewpoint of a driver thus allowing the user to visually recognize the display light as an enlarged virtual image.

As shown in FIG. 5, the display device 1 is housed in an instrumental panel 2 of a vehicle on a hood 3 side. As also shown in FIG. 6, the display device 1 includes: a display body 5 (rotary body); a support body 6 which pivotally and rotatably supports the display body 5; a rotating mechanism part 8 which rotates the display body 5; and a housing 9 (shown in FIG. 5) which houses the display body 5, the support body 6, and the rotating mechanism part 8 therein. In this embodiment, impact absorbing portions 7 which move the display body 5 in an impact direction with respect to the support body 6 is provided to the display body 5.

An advancing direction of the vehicle shown in FIG. 5 is indicated by an arrow Z, a vehicle width direction is indicated by a direction (an arrow X direction in FIG. 6) orthogonal to a paper surface direction in FIG. 5, and a direction orthogonal to both the arrow Z direction and the arrow X direction is indicated by an arrow Y direction. Further, in this specification, there may be a case where the arrow Z direction is referred to as a longitudinal direction, the arrow X direction is referred to as a lateral direction, and the arrow Y direction is referred to as a vertical direction. An arrow Z-X direction indicates a horizontal direction.

As shown in FIG. 6, the display body 5 includes: a concave mirror 51 (body portion) which reflects a display light emitted from a display unit such as a liquid crystal display not shown in the drawing toward a windshield 4; and a pair of shaft portions 52 which is mounted on both sides of the concave mirror 51 in the lateral direction (in the arrow X direction). In the display body 5, a position of a virtual image which a driver visually recognizes is adjusted by rotating the concave mirror 51 about the respective shaft portions 52. Each shaft portion 52 is configured to have a length which enables the shaft portion 52 to penetrate a raised plate 62 of the support body 6. In a state where the display body 5 is pivotally supported on the support body 6, a cut-out portion 7 (impact absorbing portion) is formed on intermediate portions of the shaft portions 52 between the concave mirror 51 and the pair of respective raised plates 62 of the support body 6 by cutting away portions of the shaft portions 52 in a wedge shape. The cut-out portion 7 is formed only on a lower side (on a side where the base plate 61 of the support body 6 exists) of the shaft portion 52. In this manner, by forming the cut-out portion 7 on the shaft portion 52, when a vehicle causes a collision accident with a pedestrian, for example, the shaft portion 52 is broken at the cut-out portion 7 due to an impact from a hood 3 side and hence, the concave mirror 51 (display body 5) is moved toward an impact direction side from the support body 6.

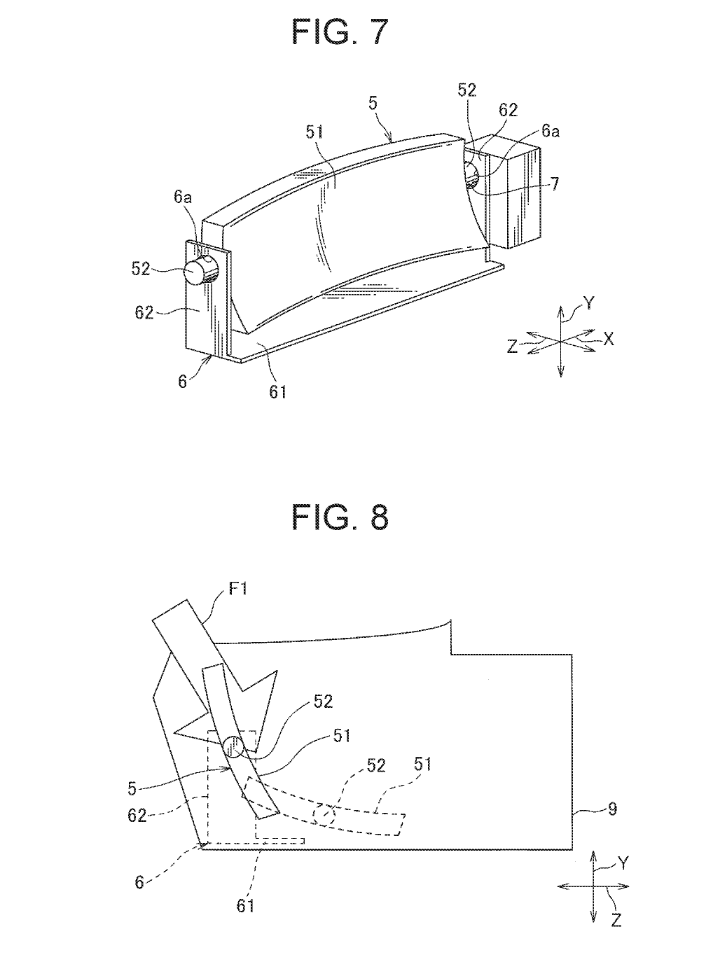

As shown also in FIG. 7, the support body 6 is formed by applying bending to one sheet of elongated metal plate, and includes: a base plate 61, and a pair of raised plates 62 which is formed by bending at predetermined positions of the base plate 61. The pair of raised plates 62 is arranged to face each other in an opposed manner. A distance between the pair of raised plates 62 in an opposedly facing direction (in an arrow X direction) is set larger than a size of the concave mirror 51 in the arrow X direction.

As shown in FIG. 7, a circular shaft hole 6a which allows the shaft portion 52 of the display body 5 to pass therethrough is formed in the raised plate 62. The shaft hole 6a is formed at a position away from a lower end of the raised plate 62 by a predetermined distance such that a lower end of the concave mirror 51 is positioned in a spaced-apart manner from the base plate 61. By making the shaft portions 52 of the display body 5 pass through the shaft holes 6a, the concave mirror 51 is rotatably supported on the support body 6 in a state where the lower end of the concave mirror 51 is spaced apart from the base plate 61.

As shown in FIG. 5, the housing 9 is made of a synthetic resin which is easily damaged when an impact is applied. An opening portion (not shown in the drawing) through which a display light is radiated toward a front glass is formed in the housing 9 at a position where the housing 9 faces the windshield 4 in an opposed manner. The opening portion is closed by a light transmissive cover.

Next, the manner of operation of the display device 1 having the above-mentioned configuration when an impact load F1 in an impact direction (for example, an impact load generated by a collision accident with a pedestrian) is applied to the display device 1 is described with reference to FIG. 8. In the display device 1 of the present invention shown in FIG. 5, for example, when a vehicle causes a collision accident with a pedestrian, an impact load F1 is applied to a portion of the vehicle in the vicinity of the display device 1 due to an impact from a hood 3 side, the housing 9 is broken and the impact load F1 is applied to the shaft portions 52 of the display body 5. As a result, the shaft portions 52 are broken at cut-out portions 7 so that a concave mirror 51 moves in an impact direction from the support body 6. That is, when the impact load F1 is applied to the vehicle, the display body 5 is moved in the impact direction so that an impact is absorbed. Accordingly, for example, even when a vehicle causes a collision accident with a pedestrian, the concave mirror 51 is moved and hence, the impact load F1 can be efficiently absorbed thus alleviating the impact load F1 applied to the pedestrian.

In the above-mentioned embodiment, the cut-out portion 7 which forms the impact absorbing portion 7 is formed on a lower side of the shaft portion 52. However, the present invention is not limited to such a configuration. The cut-out portion 7 may be formed over the whole circumference of the shaft portion 52. In the above-mentioned embodiment, the cut-out portion 7 is used as the impact absorbing portion 7. However, the present invention is not limited to such a configuration. The impact absorbing portion 7 may be formed such that a diameter size of the impact absorbing portion 7 is set smaller than diameter sizes of portions of the shaft portion 52 other than the impact absorbing portion 7. That is, the shaft portion 52 may be formed such that the rigidity of a portion of the shaft portion 52 (the impact absorbing portion) becomes lower than the rigidity of other portions of the shaft portion 52 so as to enable the movement of the display body 5 in an impact direction with respect to the support body 6 when an impact is applied to the vehicle.

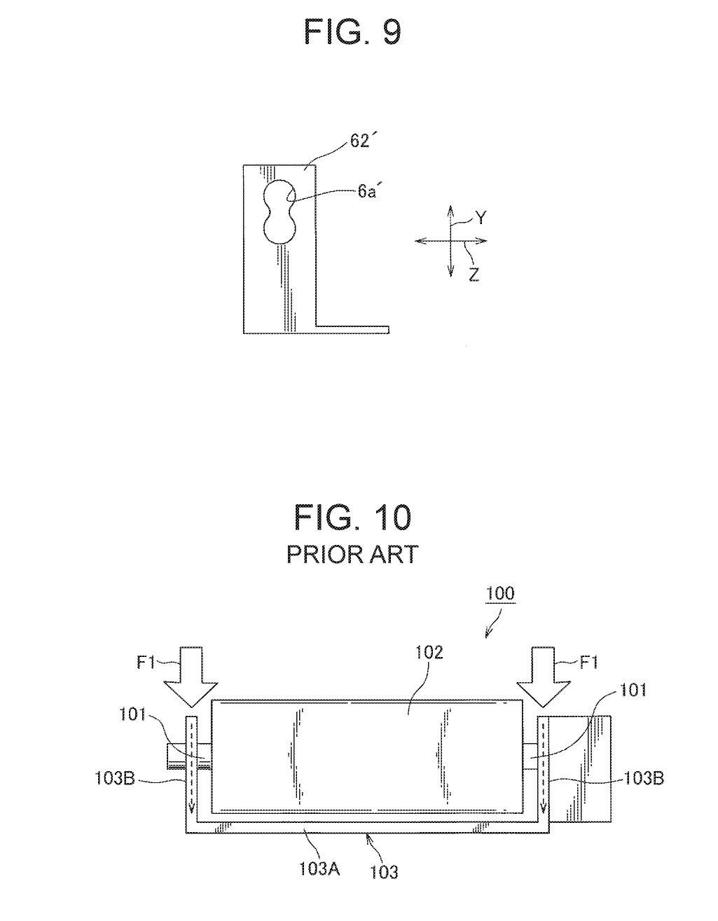

In the above-mentioned embodiments, the impact absorbing portion 7 is formed on the display body 5. However, the present invention is not limited to such a configuration. The impact absorbing portion 7 may be formed on the pair of raised plates 62 of the support body 6. In this case, as shown in FIG. 9, a shaft hole 6a′ which forms an impact absorbing portion may be formed into a gourd shape (an elliptical shape with a center portion narrowed similar to a shape of a gourd). Further, in the above-mentioned embodiment, the shaft hole 6a, 6a′ is formed in the raised plate 62 in a penetrating manner. However, the present invention is not limited to such a configuration. The shaft hole 6a, 6a′ may be formed of a recessed portion formed on the raised plate 62. That is, the shaft hole 6a, 6a′ may be formed such that the rigidity of a portion (an impact absorbing portion) of the shaft hole 6a, 6a′ is set lower than the rigidity of other portions of the shaft hole 6a, 6a′ so as to enable the movement of the display body 5 in an impact direction with respect to the support body 6 when an impact is applied to the vehicle.

In the above-mentioned fifth embodiment, the description is made with respect to the case where the concave mirror 51 is exemplified as the body portion. However, the present invention is not limited to such a case. A display unit per se may be used as the body portion, or another electronic equipment may be used as the body portion.

In the above-mentioned embodiments, the description is made with respect to the case where the impact direction is a direction that an impact is applied from a hood 3 side. However, the present invention is not limited to such a case. It is sufficient that the impact direction is a direction which intersects with a projecting direction (arrow X direction) of the shaft portion 52 of the support body 6.

The above-mentioned embodiments merely describe the typical configurations of the present invention, and the present invention is not limited to the above-mentioned embodiments. That is, various modifications can be carried out without departing from the gist of the present invention.

### REFERENCE SIGNS LIST

1: display device (vehicle-mounted device)
5: display body (rotary body)
6: support body
7: cut-out portion (impact absorbing portion)
11: rotary shaft
12: concave mirror (rotary body, reflective member)
13: stay (support body)
51: concave mirror (body portion, reflective member)
52: shaft portion
61: base plate
62: (a pair of) raised plate
131: base portion
132: raised wall portion
133: distal end portion
135: end portion

1. A vehicle-mounted device mounted on a vehicle, the vehicle-mounted device comprising:
a rotary body which is rotatable about a rotary shaft; and
a support body formed of a base portion and a pair of raised wall portions raised from the base portion and supporting the rotary shaft, wherein
distal end portions of the pair of raised wall portions are formed in an obliquely bent manner toward directions away from each other so that the pair of raised wall portions is formed into a shape which allows the raised wall portions to be deformable with a load applied in a raised direction.

2. The vehicle-mounted device according to claim 1, wherein end portions of the pair of raised wall portions on the base portion side are formed obliquely so as to be gradually away from each other in a direction toward the distal end portions of the pair of raised wall portions.

3. The vehicle-mounted device according to claim 1, wherein the raised wall portion is bent in a bellows shape.

4. The vehicle-mounted device according to claim 2, wherein the raised wall portion is bent in a bellows shape.

5. A vehicle-mounted device mounted on a vehicle, the vehicle-mounted device comprising:
a rotary body; and
a support body rotatably and pivotally supporting the rotary body, wherein
the rotary body includes a body portion and a shaft portion mounted on the body portion in a projecting manner,
a cut-out portion as an impact absorbing portion which moves the rotary body in an impact direction with respect to the support body in response to applying of an impact to the vehicle is provided to the rotary shaft of the rotary body.

6. The vehicle-mounted device according to claim 5, wherein
the support body includes a pair of raised plates which is disposed in a spaced-apart manner from each other and sandwiches the body portion in a projecting direction of the shaft portion, and
the cut-out portion is formed on an intermediate portion between the body portion and the raised plate.

7. A vehicle-mounted device mounted on a vehicle, the vehicle-mounted device comprising:
a rotary body; and
a support body rotatably and pivotally supporting the rotary body, wherein
the support body is provided with a shaft hole as an impact absorbing portion which moves the rotary body in an impact direction with respect to the support body in response to applying of an impact to the vehicle is provided to the rotary body, and wherein the shaft hole is formed in an elliptical shape with a center portion narrowed.

8. A display device comprising the vehicle-mounted device according to claim 1, wherein the rotary body is formed of a reflective member which reflects a display light.

9. A display device comprising the vehicle-mounted device according to claim 2, wherein the rotary body is formed of a reflective member which reflects a display light.

10. A display device comprising the vehicle-mounted device according to claim 3, wherein the rotary body is formed of a reflective member which reflects a display light.

11. A display device comprising the vehicle-mounted device according to claim 4, wherein the rotary body is formed of a reflective member which reflects a display light.

12. A display device comprising the vehicle-mounted device according to claim 5, wherein the rotary body is formed of a reflective member which reflects a display light.

13. A display device comprising the vehicle-mounted device according to claim 6, wherein the rotary body is formed of a reflective member which reflects a display light.

14. A display device comprising the vehicle-mounted device according to claim 7, wherein the rotary body is formed of a reflective member which reflects a display light.
